(19) United States
(12) Patent Application Publication
(10) Pub. No.: US 2024/0418902 A1
(43) Pub. Date: Dec. 19, 2024

(54) DIAMAGNETICALLY STABILIZED MAGNETICALLY LEVITATED GRAVIMETER AND METHOD

(71) Applicant: BAYLOR UNIVERSITY, Waco, TX (US)

(72) Inventors: Alexandre Yokochi, Waco, TX (US); Peter James, Waco, TX (US); Annette Von Jouanne, Waco, TX (US)

(73) Assignee: BAYLOR UNIVERSITY, Waco, TX (US)

(21) Appl. No.: 18/743,563

(22) Filed: Jun. 14, 2024

Related U.S. Application Data
(60) Provisional application No. 63/521,241, filed on Jun. 15, 2023.

(51) Int. Cl. G01V 7/02; G01V 7/16; G01V 13/00

(52) U.S. Cl. CPC G01V 7/02; G01V 7/16; G01V 13/00

(57) ABSTRACT

The disclosure provides a diamagnetically stabilized magnetically levitated gravimeter and related method that allows measurements of relative gravity in a simple, low power consumption device based on a magnetic levitation principle using permanent magnets instead of using a mechanical spring. The gravimeter uses magnetic forces to balance a float magnet against the force of gravity, allowing for accurate measurements. The gravimeter includes a float magnet that floats between two diamagnetic materials, such as diamagnetic plates, without a need for external energy input due to the interaction between the magnetic forces of the float magnet lifted by the lift magnet but stabilized between upper and lower diamagnetic materials. The gravimeter is less sensitive to drift in response to stresses than a mechanical spring, have a lower temperature sensitivity, and lower energy and power requirements to take similarly reliable gravity measurements, which in turn simplify deployment and prolong operational lifetime.

### CROSS REFERENCE TO RELATED APPLICATIONS

This application claims the benefit of U.S. Provisional Application No. 63/521,241, filed Jun. 15, 2023, entitled “Diamagnetically Stabilized Magnetically Levitated Gravimeter and Method”, and is incorporated herein by reference.

### STATEMENT REGARDING FEDERALLY SPONSORED RESEARCH OR DEVELOPMENT

Not applicable

### REFERENCE TO APPENDIX

No applicable

### BACKGROUND OF THE INVENTION

### Field of the Invention

The disclosure generally relates to devices and methods for measuring gravity. More particularly, the disclosure relates to devices and methods for measuring gravity, even with various gravitational constants in different environments.

### Description of the Related Art

Gravity is a valuable means of determining the distribution of mass of terrestrial and celestial bodies. Currently, gravity information for celestial bodies other than Earth is mainly obtained from orbiting satellites via Doppler ranging and satellite-to-satellite tracking. A gravimeter situated on the surface would provide measurement abilities that cannot be achieved from orbit.

Satellites can measure gravity on a global scale, but not at finer length scales. The Gravity Recovery and Interior Laboratory (GRAIL) mission to the Moon collected the highest resolution gravity data to date, but still had limitations in spatial resolution due to attenuation. Thus, surface gravimetry will be necessary to determine gravity anomalies at scales less than several kilometers. Typically, spacecraft measure the gravity potential field outside a celestial body, using the Brillouin sphere as a reference point. The Brillouin sphere is the smallest sphere centered at the body's barycenter that covers all its topography. Any Doppler ranging or satellite-to-satellite tracking beyond this sphere cannot be used to confidently estimate gravitational potential at altitudes below it. The shape and gravitational field of a celestial body deforms in response to tidal forces, and these tidal responses produce signals that are measurable by a gravimeter. While Love numbers have been estimated from orbit and from ground displacement measurements, a gravimeter would provide an independently coupled estimate of the k and h Love numbers.

It is difficult to measure gravity inside the Brillouin sphere from orbit due to external potential divergence, and surface gravity measurements have large uncertainties. Measuring absolute gravity would require calibration on Earth and precise measurements during launch. However, a relative gravimeter measurement could still provide useful data by taking multiple measurements over longer distances.

As a result, the gravitational Love numbers of different bodies are not well-constrained for spherical harmonic degrees greater than 2. A gravimeter that remains stationary on the surface of a body could more accurately detect the changes in gravitational acceleration caused by tidal deformation. Having such a system deployed could also help make other measurements, like detecting lava tubes on the moon, estimating the local terrain of a planet, and generally help understand the planetary internal structure.

Lava tubes, void spaces resulting from volcanic activity, create a characteristic gravity deficit. The width of these tubes can be inferred from the shape of the observed gravity anomaly, although this gets complicated with non-cylindrical tube shapes. Lava tubes are larger on bodies with weaker gravity, such as the Moon, where they could reach widths of a few kilometers. The radiation shielding provided by the ceiling of a lava tube makes these structures a suitable base for human exploration and settlement. While lava tubes on the Moon are difficult to identify from orbit, a gravimeter mounted on a rover would be an effective means of detecting them. Surface-based gravimetry could plausibly detect lunar lava tubes by measuring relative gravity with an error of less than 20 mGal, where 1 Gal, sometimes called a “galileo” after Galileo Galilei, is a unit of acceleration commonly used in precision gravimetry and is defined as 1 cm per second squared (1 cm/s²).

Gravity anomalies can be used to estimate the bulk density of a planetary body's local terrain, which can be determined using the Nettleton-Parasnis method. Measuring bulk density at different scales and locations can reveal vertical profiles and three-dimensional variations. Bulk density can be used to investigate mineralogy, the presence of dense igneous bodies, the presence of ice, and porosity, which is dependent on impact history and regolith formation processes. Sedimentary rock density on a planet like Mars can provide insights into deposition methods and depth of burial. Gravity signals associated with many of these phenomena exceed 1 mGal.

Tidal deformation is a powerful tool for understanding a planetary body's internal structure and can reveal information such as the size of a liquid metal core or the presence of subsurface oceans. It can also indicate tidal dissipation and geophysical phenomena, such as volcanism, geysers, ocean, and energetic conditions that could be suitable for microbial life. Tidal tomography, which maps the deep interior of a planetary body, is a promising technique that could reveal heterogeneities caused by magma ocean overturn and thermochemical convection. Hemispheric dichotomies in surficial geology are a topic of interest in planetary science, and tidal deformation may offer insights into their origins. By measuring gravity at a single location, surface-based gravimetry can measure a tidal gravity perturbation (<200 μGal for a full tidal cycle). Ultra-high-precision measurements could potentially resolve deep mantle heterogeneities (<0.3 μGal for a full tidal cycle) or detect earthquakes instantaneously (<1 μGal).

The acceleration of gravity can be measured using various instruments, including the free-fall of a test mass in a vacuum and superconducting levitation of a test mass, but they are too massive for field geophysics or spacecraft missions. The most common type of gravimeter used in terrestrial geophysics is the spring-based gravimeter, which measures changes in gravitational acceleration in time and space. However, these instruments have limitations for scientific investigations beyond Earth. An example of a commercially available instrument is the Scintrex CG-6 Autograv gravimeter, which uses a fused quartz spring.

A variety of gravimeter designs have been built, and an even greater diversity of designs have been proposed. Global gravity fields can be recovered by orbiting spacecraft with a variety of detection techniques (e.g., GOCE, GRACE, and GRAIL), but these datasets are practically limited in their horizontal resolution by their altitude. For Earth, the finest resolution of orbital measured static gravity fields is a few hundred kilometers. Consequently, ground-based gravimeters are needed to map shorter-wavelength anomalies. Whereas “absolute” gravimeters directly measure the amplitude of gravity acceleration (e.g., through free fall). Relative gravimetry is more practical for field deployment and relative gravimeters measure relative changes in acceleration.

In a spring-based instrument, changes in temperature can significantly affect the restoring force of the mechanical spring. To mitigate this, some modern gravimeters use fused quartz springs with low thermal expansion coefficients. However, temperature fluctuations can still lead to large changes in apparent gravity readings.

To overcome the temperature sensitivity, these gravimeters are typically heated to maintain a constant temperature, causing them to require significant energy and power resources to accomplish this. For example, the Scintrex CG-6 gravimeter weighs 5.2 kg without an autonomous leveling system, with the weight due in part to the instrument's thermal regulation components. These requirements would be even higher to maintain a constant temperature on the moon.

Finally, during launch, separation, entry, descent, and landing, springs in gravimeters can experience an elastic change in length, known as “tares.” In addition, delicate springs can be damaged if the gravimeter is inverted while the test mass is unlocked. Locking and unlocking the test mass can also introduce tares in the spring. The most common relative gravimeter design balances the force of gravity against known elastic stresses, including a zero-length spring or a vibrating string. Micro-electromechanical systems (MEMS) similarly balance the strength of gravity against elasticity, and gravimeters based on these principles have made great strides in recent years.

All elasticity-based gravimeter sensors suffer from similar limitations, including temperature sensitivity, ambient noise, and instrument drift. Sensors based on electromagnetic forces could plausibly exhibit improved performance regarding these limitations and may, therefore, be desirable for some applications. A gravimeter that uses electrostatic forces has been proposed, but this design still incorporates an elastic spring. Superconducting gravimeters do not rely on elasticity, but they are bulky and impractical for mobile deployment.

Thus, there remains a need for improvements in gravimeters and the methods of use.

### BRIEF SUMMARY OF THE INVENTION

The disclosure provides a gravimeter and related method that allows measurement of the acceleration of gravity in a simple, low power consumption device that is based on a magnetic levitation principle using permanent magnets instead of using a mechanical spring. The device, herein called a diamagnetically stabilized magnetically levitated (DSML) gravimeter, uses magnetic forces to balance a test mass against the force of gravity, allowing for accurate measurements. A DSML gravimeter includes a float magnet, diamagnetic material, and a lift magnet. The float magnet levitates in a position relative to one or more diamagnetic materials, such as diamagnetic plates, without a need for external energy input due to the interaction between the magnetic forces of the float magnet lifted by the lift magnet but stabilized relative to at least one diamagnetic material. The gravimeter is less sensitive to drift in response to stresses than a mechanical spring, has a much lower temperature sensitivity, and consequently much lower energy and power requirements to take similarly reliable gravity measurements, which in turn simplify deployment and prolong operational lifetime. Compared to existing alternatives, a gravimeter that incorporates diamagnetic levitation would have the benefit of improved stability, reduced noise, improved sensitivity, and operation at even room temperatures. The device could be useful for studying subsurface composition with high sensitivity, precision, and accuracy both on earth as well as in space or other planets.

The disclosure provides a gravimeter, comprising: a first diamagnetic material; a float magnet disposed longitudinally separate from the first diamagnetic material; and a lift magnet disposed longitudinally from the float magnet with the first diamagnetic material disposed between the lift magnet and the float magnet, the lift magnet configured to levitate the float magnet with a magnetic force that opposes a gravitational force on the float magnet while the diamagnetic material exerts a repulsive force on the float magnet.

The disclosure also provides a method of operating a gravimeter, comprising: positioning a gravimeter in a first gravitational field, the gravimeter having a first diamagnetic material; a float magnet disposed longitudinally separate from the first diamagnetic material; and a lift magnet disposed longitudinally from the float magnet with the first diamagnetic material longitudinally disposed between the lift magnet and the float magnet with the float magnet levitating; determining a first longitudinal position of the float magnet in the first gravitational field; determining a second longitudinal position of the float magnet in a second gravitational field different than the first gravitational field; and determining the difference between the first and second longitudinal positions to determine an amount of change between the gravitational fields.

The disclosure further provides a gravimeter, comprising: a first diamagnetic material and a second diamagnetic material, the first diamagnetic material disposed longitudinally separate from the second diamagnetic material; a float magnet disposed longitudinally between the first diamagnetic material and the second diamagnetic material; and a lift magnet disposed longitudinally from the float magnet with at least one of the diamagnetic materials disposed between the lift magnet and the float magnet and configured to levitate the float magnet between the first and second diamagnetic materials.

A method of operating a gravimeter, comprising: positioning a gravimeter in a first gravitational field, the gravimeter having a float magnet disposed longitudinally between a first diamagnetic material and a second diamagnetic material and having a lift magnet disposed longitudinally from the float magnet with at least one of the diamagnetic materials disposed between the lift magnet and the lift magnet levitating the float magnet between the diamagnetic materials; determining a first longitudinal position of the float magnet in the first gravitational field; determining a second longitudinal position of the float magnet in a second gravitational field different than the first gravitational field; and determining the difference between the first and second longitudinal positions to determine an amount of change between the gravitational fields.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a schematic side view diagram of a model showing principles of a conceptual DSML gravimeter.

FIG. 2 is a schematic side view diagram of a conceptual DSML gravimeter with forces associated with the gravimeter.

FIG. 3A is a schematic diagram of an exemplary embodiment of a proposed DSML gravimeter.

FIG. 3B is a schematic diagram of forces and their direction acting on the float magnet in FIG. 3A and FIG. 3D.

FIG. 3C is a schematic diagram of a restoring force when the float magnet is moved from an equilibrium elevation with the other forces being constant.

FIG. 3D is a schematic diagram of another exemplary embodiment of the proposed DSML gravimeter.

FIG. 3E is a schematic diagram of another exemplary embodiment of the proposed DSML gravimeter.

FIG. 3F is a schematic diagram of forces and their direction acting on the float magnet in FIG. 3E.

FIG. 4A is a schematic side view of an embodiment of the DSML gravimeter having a dampener for moderating movement of the float magnet.

FIG. 4B is a schematic side view of an embodiment of the DSML gravimeter having a different float magnet than the float magnet illustrated in FIG. 4A.

FIG. 5A is a schematic cutaway diagram of a finite element analysis (FEA) model of the DSML gravimeter.

FIG. 6A is an example of a graph of restoring force in the y-axis with respect to displacement curves in the x-axis for different relative permeability.

FIG. 6B is a graph of a magnetic spring constant in the y-axis with respect to the corresponding relative permeability μᵣ in the x-axis based on the results shown in FIG. 6A.

FIG. 7A is an example of a graph of restoring force in the y-axis with respect to various displacements in the x-axis for different diamagnetic spacing L₂.

FIG. 7B is a graph of a magnetic spring constant in the y-axis with respect to the corresponding diamagnetic spacing L₂ displacement in the x-axis based on the results shown in FIG. 7A.

FIG. 8A is an example of a graph of restoring force with respect to various displacements for a wide range of diamagnetic spacing L₂ between the two diamagnetic materials.

FIG. 8B is a graph of a magnetic spring constant gradient with respect to the diamagnetic spacing L₂ shown in FIG. 8A.

FIG. 9A is an example of a 3D surface graph of restoring force with respect to displacement on the x-axis for different diamagnetic spacing L₂ on the y-axis and magnetic spacing L₁ on the z-axis.

FIG. 9B is a side view graph of restoring force with respect to displacement for diamagnetic spacing L₂=14 mm (corresponding to 1 mGal) from the information of FIG. 9A.

FIG. 10A is an example of a 3D surface graph of spring stiffness response on a z-axis with respect to diamagnetic spacing L₂ on an x-axis and magnetic spacing L₁ on the y-axis.

FIG. 10B is a side view graph of the 3D spring stiffness response surface with respect to displacement for L₂=14 mm from the information of FIG. 10A.

FIG. 11 is an example of a graph of force minus displacement (F−Δ) characteristic profiles for different bottom diamagnetic bore radius R.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up”, “upper”, “upward”, “bottom”, “lower”, “down”, “downwardly”, and like directional terms are used to indicate the direction relative to the figures and their illustrated orientation and are not absolute relative to a fixed datum such as the earth in commercial use. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Some elements are described with a given element number and where helpful to describe embodiments with various examples are provided in the description and figures that perform various functions and are non-limiting in shape, size, description, but serve as illustrative structures that can be varied as would be known to one with ordinary skill in the art given the teachings contained herein. Element numbers with suffix letters, such as “A”, “B”, and so forth, are to designate different elements within a group of like elements having a similar structure or function, and corresponding element numbers without the letters are to generally refer to one or more of the like elements.

The disclosure provides a diamagnetically stabilized magnetically levitated gravimeter and related method that allows measurements of relative gravity in a simple, low power consumption device based on a magnetic levitation principle using permanent magnets instead of using a mechanical spring. The gravimeter uses magnetic forces to balance a float magnet against the force of gravity, allowing for accurate measurements. A gravimeter includes a float magnet that floats between two diamagnetic materials without a need for external energy input due to the interaction between the magnetic forces of the float magnet lifted by the lift magnet but stabilized between upper and lower diamagnetic materials. The diamagnetic materials can be formed into various shapes, such as diamagnetic plates having a greater cross-sectional dimension than a longitudinal thickness. The gravimeter is less sensitive to drift in response to stresses than a mechanical spring, has a lower temperature sensitivity, and lower energy and power requirements to take similarly reliable gravity measurements, which in turn simplify deployment and prolong operational lifetime.

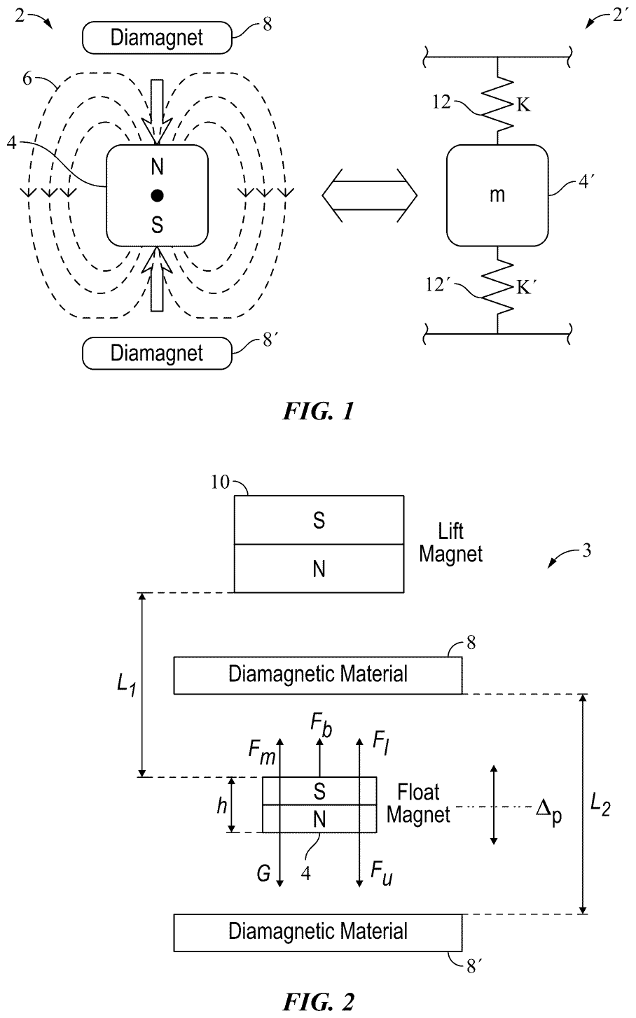

FIG. 1 is a schematic side view diagram of a model showing principles of a conceptual DSML gravimeter. The inventors realized that a robust gravimeter meeting the above goals could be developed using as a starting point a model 2 having a magnet 4 with a magnet field 6 interposed between diamagnetic materials 8A and 8B. The diamagnetic materials expel the magnetic field of a magnet 4 from the diamagnetic materials, and thus deforms the magnetic field from the magnet to create an opposing repulsive magnetic force toward the magnet away from each of the respective diamagnetic materials, that is, in an opposite direction. Such a model 2 could be further described as a model 2′ of a mass 4′ suspended between magnetic springs 12 and 12′ having spring constants K and K′, resulting from the interaction of the magnetic fields of a permanent magnet and diamagnetic materials to levitate the permanent magnet between the diamagnetic materials. With this concept of a theoretical model, the inventors developed a DSML gravimeter described herein and analyzed the design criteria discussed herein that is believed to be needed for such a DSML gravimeter. This DSML gravimeter should be less sensitive to drift in response to stresses than a mechanical spring, have much lower temperature sensitivity, and consequently much lower energy and power requirements to take similarly reliable gravity measurements, which in turn simplify deployment and prolong operational lifetime. A dampener can inductively dampen the motion of the float magnet through eddy current braking, which would mitigate ambient noise affecting the magnetic fields.

FIG. 2 is a schematic side view diagram of a conceptual DSML gravimeter with forces associated with the gravimeter. The diagram of the DSML gravimeter 2 includes a float magnet 4 lifted by a lift magnet 10 that is in at least one embodiment is mounted stationary above the float magnet. The float magnet 4 and lift magnet 10 are situated so different poles face each other to establish magnetic attraction. Thus, the lifting force Fₘ on the float magnet 4 from the lift magnet 10 will be upward and opposing the downward gravitational force F_{g}. The force Fₘ acting on the float magnet is generally equal to or greater than the gravitational force F_{g}. The amount of force Fₘ of the lift magnet 10 on the float magnet 4 depends on a distance between the magnets 4 and 10. The magnet spacing L₁ is the distance between a bottom surface of the lift magnet 10 and an upper surface of the float magnet 4, that is, opposing faces of the magnets. The diamagnetic spacing L₂ is the distance between the opposing surfaces of the diamagnetic materials 8 and 8′. The height of the float magnet is h.

Alternatively, the lift magnet 10 can be positioned below the float magnet 4 and situated so like poles face each other to establish magnetic repulsion. The magnetic repulsion from a lower position likewise creates a lifting force Fₘ on the float magnet 4 from the lift magnet 10 that will be upward and opposing the downward gravitational force F_{g}.

The float magnet 4 is disposed between an upper diamagnetic material 8 and a lower diamagnetic material 8′. The diamagnetic materials can be made from pyrolytic graphite, such as highly oriented pyrolytic graphite (“HOPG”), bismuth, composite graphite having graphite particles mixed in a generally non-conductive composite matrix, other diamagnetic materials mixed in a composite matrix, or other diamagnetic materials. The diamagnetic materials 8 and 8′, which can be in a form of diamagnetic plates, create opposing repulsive magnetic forces on the float magnet away from the respective diamagnetic material. With upper diamagnetic material 8 above the float magnet 4, the upper diamagnetic material deforms the magnetic field of the float magnet 4 to turn the magnetic field into an opposing force Fᵤ downward on the float magnet. Similarly, with lower diamagnetic material 8′ below the float magnet 4, the lower diamagnetic material deforms the magnetic field of the float magnet 4 to turn the magnetic field into an opposing force Fₗ upward on the float magnet. Opposing repulsive forces of Fᵤ and Fₗ from the upper diamagnetic material and the lower diamagnetic material, respectively create a steady state position of the float magnet 4 between the diamagnetic materials. These opposing repulsive forces can be characterized in formulas as having force constants K and K′, respectively. The repulsive force constants are dependent on the spacing between the face of the magnet and the respective diamagnetic material. A force F_{b} is the force of a medium in which the float magnet moves having a zero (or near zero) value in a vacuum, and a nonzero value based on the density of the medium. Thus, in operation of the DSML gravimeter having an initial equilibrium, a change in gravity force F_{g} changes the summation of forces and therefore self corrects by a change in position Δp of the float magnet 4 until a new stable position, higher or lower than the first position, is attained with an equal summation of forces.

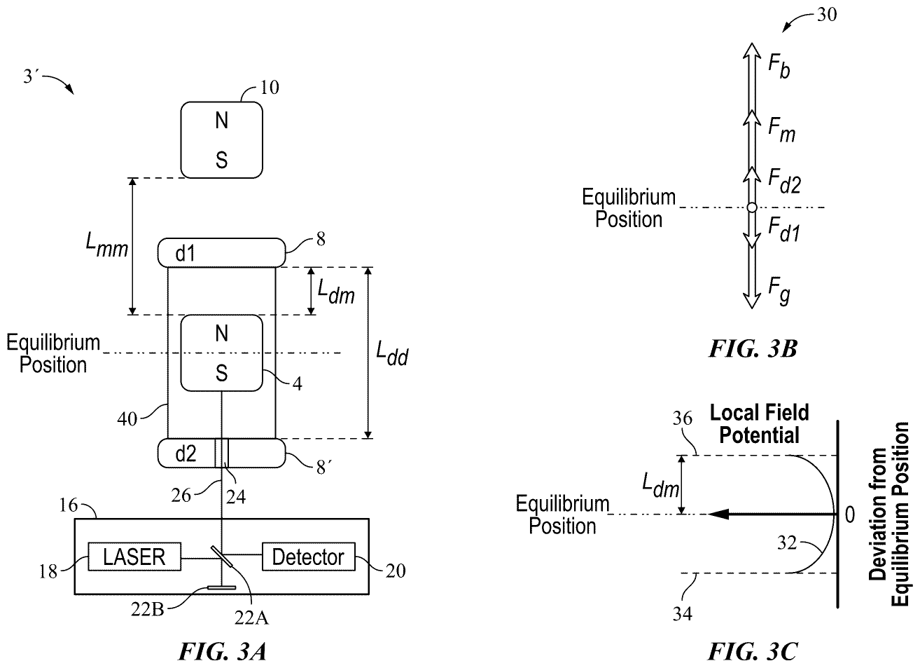

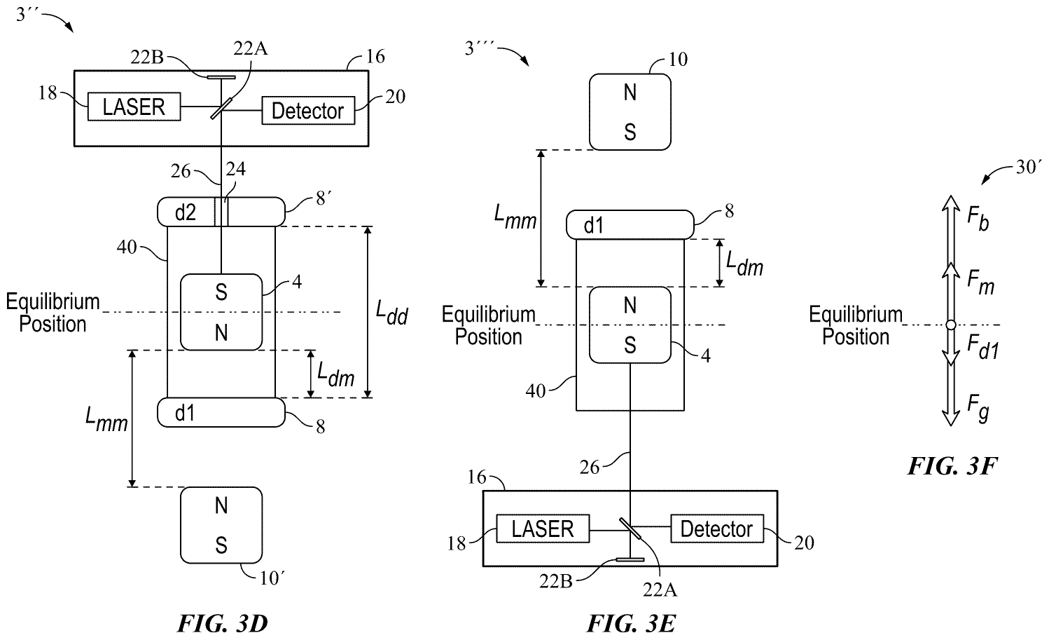

FIG. 3A is a schematic diagram of an exemplary embodiment of a proposed DSML gravimeter. As described, the DSML gravimeter 3′ includes a float magnet 4 that is magnetically lifted by a lift magnet 10 in opposition to gravity and stabilized between an upper (first) diamagnetic material 8 and a lower (second) diamagnetic material 8′. Generally, the lift magnet will be positioned above the float magnet 4 to attract the float magnet upward to counter the downward gravitational force. The lift magnet 10 can be formed from a single magnet or a plurality of magnets that together exert the lifting force for the float magnet. The lift magnet can be made of rare earth materials for high magnetic field density, such as a neodymium magnet as a permanent magnet made from an alloy of neodymium, iron, and boron to form the Nd₂Fe₁₄B with a tetragonal crystalline structure. Other magnet compositions can be used as well. The float magnet 4 can likewise be formed from a single magnet or a plurality of magnets, although practically, it is envisioned to be formed from a single magnet. The float magnet can be of a similar or different magnetic composition as the lift magnet. The shape of the magnet(s) can vary, but generally will have a direction of magnetization that is at least primarily coaxial with a longitudinal axis 14 of the stack of components for the DSML gravimeter. The diamagnet materials can be in the form of a plate having a disk shape advantageous for size and compactness having a strong diamagnetic propensity, such as described in FIG. 2 above. In at least some embodiments, a dampener 40 can moderate movement of the float magnet, as described in more detail below.

A position measuring interferometer 16 can be used to detect sensitive movements of the float magnet 4 due to changes in gravity to measure relative gravity under varying conditions. Without limitation and as an example, the position measuring interferometer 16 can include a laser 18 to emit a beam of light and a detector 20 to receive at least the beam of light reflected from the float magnet 4 to determine changes in position of the float magnet. A mirror 22A can deflect the laser beam of light to a direction toward a mirror 22B that can reflect the laser beam through the mirror 22A and through an opening 24 in at least one of the diamagnetic materials 8 and 8′, shown as the lower diamagnetic material 8′ in this embodiment. The beam of light can reflect from a surface of the float magnet 4 back through the opening 24 to the mirror 22A and then into the detector 20. The time of flight differences indicate a change in position of the float magnet 4 and an amount of the change. The change in position can be calibrated for the particular gravimeter to a change in gravimetric units.

FIG. 3B is a schematic diagram of forces and their direction acting on the float magnet in FIG. 3A and FIG. 3D. In operation, when the DSML gravimeter is at equilibrium, the vector summation 30 of the forces is zero acting on the float magnet 4. These forces include a gravitational force F_{g}, lift magnetic force Fₘ, and the two diamagnetic repelling forces (F_{d1} and F_{d2}), as illustrated in the associated force vector diagram. A surrounding medium buoyancy force (F_{b}) is generally zero in a vacuum or when the gravimeter is in equilibrium. During movement of the float magnet 4 when not in an equilibrium state, the buoyancy force F_{b} can represent a transient force.

FIG. 3C is a schematic diagram of a restoring force when the float magnet is moved from an equilibrium elevation with the other forces being constant. The x-axis illustrates an amount of positional deviation from equilibrium at the y-axis. The y-axis illustrates an amount of local field potential. When the float magnet 4 is displaced from the equilibrium point, it experiences a restoring force Fᵣ equal to the sum of the two diamagnetic repelling forces. The float magnet 4 cannot move more than the distance (L_{dm}) between the diamagnetic materials and the float magnet due to physical limitations. The greater the deviation, the greater the local field potential until the limit of positional deviation is reached at distance L_{dm}. At the maximum lower deviation 34 from equilibrium and the maximum upper deviation, the maximum values of the local field potential is reached. The separation distance between the two diamagnetic materials (L_{dd}) controls the depth of the potential well in the diamagnetic repulsion field, allowing for a softer or harder “diamagnetic response” by adjusting this distance.

FIG. 3D is a schematic diagram of another exemplary embodiment of the proposed DSML gravimeter. The embodiment shown in FIG. 3A can be reversed in orientation for the embodiment of FIG. 3D, so that the lift magnet 10′ can be located below the float magnet 4, but where the magnetic poles of the lift magnet are oriented to repel the float magnet. The force Fₘ from the repulsion of the magnets 4 and 10 can similarly lift the float magnet 4 upward by opposing the downward gravitational force F_{g}. In that orientation, the position measuring interferometer 16 can be reversed as well so that the upper diamagnetic material 8 becomes the diamagnetic material 8′ that has an opening to allow the beam of light to pass through to a surface of the float magnet to measure movement.

FIG. 3E is a schematic diagram of another exemplary embodiment of the proposed DSML gravimeter. The DSML gravimeter 3″ embodiment shown in FIG. 3E can be similar to the DSML gravimeter 3′ embodiment shown in FIG. 3A without the lower diamagnetic material 8′. The lift magnet 10′ can be located above the float magnet 4 to lift the float magnet by a magnetic force opposing a gravitational force to an equilibrium position in conjunction with the repulsive force of the diamagnetic material 8, so that the float magnet is magnetically levitated below the diamagnetic material 8. Similar to the embodiment in FIG. 3A, the position of the float magnet 4 can be measured, for example, with a position measuring interferometer 16 and associated components.

In another embodiment, the components shown in FIG. 3E could be reversed in orientation similar to the DSML gravimeter 3″ embodiment shown in FIG. 3D but combined with the embodiment of FIG. 3E without the diamagnetic material 8′, so the lift magnet 10′ is located longitudinally below the diamagnetic material 8 and the float magnet 4 is located longitudinally above the diamagnetic material 8 in a similar manner as described in FIG. 3D. The lift magnet 10′, located below the float magnet 4, can lift the float magnet to an equilibrium position in conjunction with the repulsive force of the diamagnetic material 8, so that the float magnet is magnetically levitated above the diamagnetic material 8.

FIG. 3F is a schematic diagram of forces and their direction acting on the float magnet in FIG. 3E. In operation, when the DSML gravimeter is at equilibrium, the vector summation 30′ of the forces is zero acting on the float magnet 4. These forces include a gravitational force F_{g}, lift magnetic force Fₘ, and the diamagnetic repelling force F_{d1}, as illustrated in the force vector diagram. A surrounding medium buoyancy force F_{b} is generally zero in a vacuum or when the gravimeter is in equilibrium. During movement of the float magnet 4 when not in an equilibrium state, the buoyancy force F_{b} can represent a transient force.

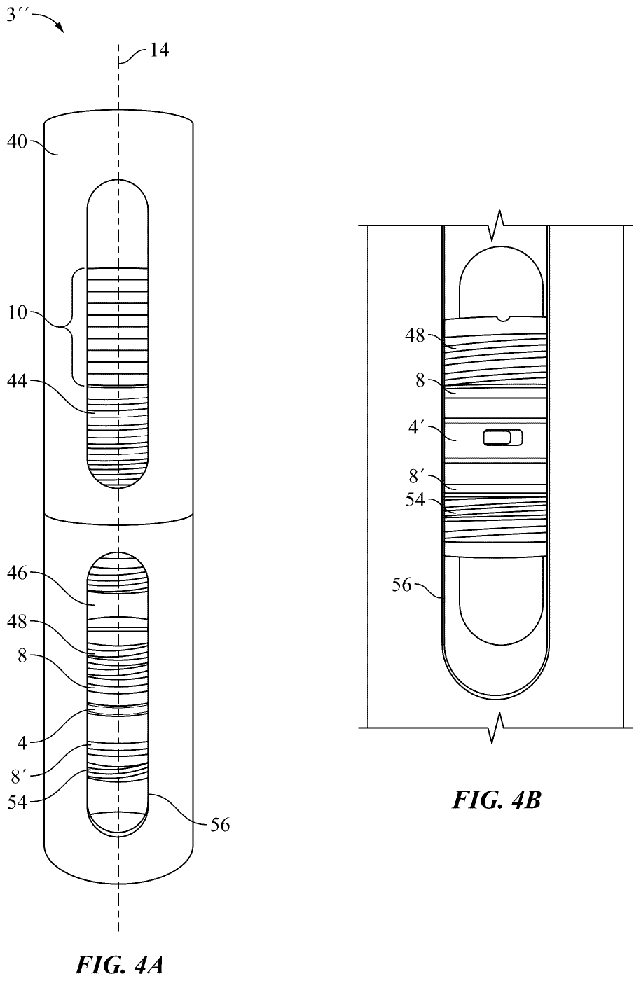

FIG. 4A is a schematic side view of an embodiment of the DSML gravimeter having a dampener for moderating movement of the float magnet. The DSML gravimeter 3″ can include a dampener 40 that can inductively dampen motion of the float magnet 4 through passive eddy current braking, which mitigates ambient noise affecting the magnetic fields and stabilizers random movement of the float magnet. The dampener 40 can include a sleeve 42 advantageously of a conductive nonmagnetic material, such as for example aluminum, brass, copper, or conductive polymeric materials such as composites mixed with conductive particles to have sufficient conductivity for this purpose. The lift magnet 10 can be positioned in an upper portion of the dampener and restrained in elevation by an adjustor 44, such as a threaded positioning screw. The adjustor can be made of various materials that are advantageously non-magnetic to avoid interference with the magnetic fields, such as brass, aluminum, polymeric compounds, and others. The adjustor 44 can be used to raise and lower the lift magnet 10 to an appropriate height along a longitudinal axis 14 of the DSML gravimeter for an appropriate lifting force on the float magnet 4. A void 46 can be designed into the dampener inner volume to allow longitudinal movement of the adjustor 44 and other adjustors along the longitudinal axis. An upper diamagnetic adjustor 48 can be set at an appropriate longitudinal position in the dampener 40 for the upper diamagnetic material 8 that can be coupled to a lower surface of the upper diamagnetic adjustor. to face the float magnet 4. Similarly, a lower diamagnetic adjustor 54 can be set at an appropriate position in the dampener for the lower diamagnetic material 8′ that can be coupled to a lower surface of the lower diamagnetic adjustor. to face the float magnet 4. A viewing port 56 can be formed in the dampener 40.

FIG. 4B is a schematic side view of an embodiment of the DSML gravimeter having a different float magnet than the float magnet illustrated in FIG. 4A. The different float magnet 4′ is illustrated for the purpose of showing that the principles of the present invention can apply to various shapes of float magnets.

The inventors envision this gravimeter being particularly useful in rugged environments, such as those having frequent impact forces, those having temperature extremes, those having little or no access to external energy, and other such environments that would potentially render typical gravimeter inaccurate at best and potentially useless and destroyed at worst. Some of the exemplary uses could be on various robotic spacecraft, such as landers and rovers, to study the interiors of rocky and icy celestial bodies.

### Basic Principles of Diamagnetically Stabilized Magnetic Levitation

In more detail and to provide support for the invention, the following disclosure is made. The magnetic energy of an object of volume V and magnetic susceptibility χ in a field of magnetic flux density \vec{B} is given by:

$${E}_{mag} = - \frac{1}{2 μ} {χ VB}^{2} \qquad ( 1 )$$

and since \vec{F}=\vec{∇}E, the magnetic force (in N) experienced by a magnetic system is:

$${\vec{F}}_{mag} = \frac{χ}{μ} V ( \vec{B} \cdot \vec{V} ) \vec{B} \qquad ( 2 )$$

and depends on the magnetic susceptibility of the material, χ (non-dimensional), its volume, V (m³), the magnetic flux density of the applied field, \vec{B} (T), the gradient of the magnetic field, \vec{B}·\vec{V} (T/m), and the permeability of free space, μ₀=4π×10⁻⁷ H/m.

If an object is either ferromagnetic or paramagnetic (χ>0), it will show a positive result with a positive value of magnetic force (\vec{F}_{mag}), indicating that it is attracted to the magnetic field. On the other hand, if the material is diamagnetic (χ<0), it will display a negative result with a negative magnetic force (\vec{F}_{mag}), indicating that it is being repelled by the magnetic field. Essentially, materials that have a greater magnetic susceptibility than their surroundings are pulled toward high magnetic field areas, and conversely, materials with a magnetic susceptibility smaller than their surroundings are expelled from high magnetic field areas.

Magnetic objects can be trapped in stable locations, but only in areas where there is a maximum magnetic field. Thus, materials with greater magnetic susceptibility than their surroundings can only be stably trapped at the source of the magnetic field. However, magnetic field minima can be created outside of a magnetic field source, which allows for the levitation and confinement of diamagnetic materials like biological materials. In contrast, ferromagnetic materials can be trapped between two diamagnetic plates at the minimum energy location created by the magnetic field.

The DSML gravimeter relies on trapping the float magnet 4, generally a strong permanent magnet, in the energy minimum between the two diamagnetic materials 8 and 8′ (the location where E_{mag} is a minimum according to Equation (1)), where any restoring force Fᵣ is determined by the magnetic force as described by the equation. Thus, any deviation of the object from the minimum energy location results in a magnetic force (\vec{F}_{mag}) of Equation (2) that acts to restore the object to that location.

### Mathematical Foundations

Using principles above to the schematic diagram of FIG. 2, the inventors developed a mathematical foundation for a model to design the DSML gravimeter. The resultant restoring force Fᵣ is given as

$${F}_{r} = {F}_{m} + {F}_{l} - {F}_{u} - G \qquad ( 3 )$$

where Fₘ is the force exerted on the float magnet by the lift magnet, Fₗ and Fᵤ are the lower and upper opposite repulsive forces exerted on the float magnet by two diamagnetic materials that are in this example being highly oriented pyrolytic graphite (HOPG) sheets, and G is the gravitational force on the float magnet.

Refining the above principles to include the effect of buoyancy on the restoring force in the case that the chamber pressure is above vacuum such that the new restoring force Fᵣ* includes the buoyancy force, i.e.,

$${F}_{r}^{*} = {F}_{m} + {F}_{l} - {F}_{u} - {G}^{*} \qquad ( 4 )$$

$${G}^{*} = G - {F}_{B} \qquad ( 5 )$$

F_{B} is the buoyancy force, and

$$\\ \begin{matrix}G = mg = ρ Vg , {F}_{B} = {ρ}^{{}_{} *} Vg , {G}^{{}_{} *} = ( ρ - {ρ}^{{}_{} *} ) Vg & ( 6 )\end{matrix}$$

ρ* is the density of the medium,

$$\\ \begin{matrix}{G}^{{}_{} *} = ρ {Vg}^{{}_{} *} & ( 7 )\end{matrix}$$

where g* is the effective local gravitational acceleration.

$$\\ \begin{matrix}{g}^{{}_{} *} = ( \frac{ρ - {ρ}^{*}}{ρ} ) g & ( 8 )\end{matrix}$$

The radial, Bᵣ, and axial, B_{z}, magnetic field components described in an axisymmetric cylindrical coordinate system, therefore, defined only by a radial, r, and height, z, coordinate for a magnet with magnetic dipole moment, M_{d}, immersed in a medium with the magnetic permeability of vacuum, μ₀, is given analytically by

$$\\ \begin{matrix}{B}_{r} ( r , z ) = \frac{{μ}_{0} {M}_{d}}{4 π} [ 3 \frac{rz}{{a}^{{}_{} 5}} ] , {B}_{z} ( r , z ) = \frac{{μ}_{0} {M}_{d}}{4 π} \frac{1}{{a}^{{}_{} 3}} [ 3 \frac{{z}^{{}_{} 2}}{{a}^{{}_{} 2}} - 1 ] , and & ( 9 )\end{matrix}$$

$$\\ a ( r , z ) = \sqrt{{r}^{{}_{} 2} + {z}^{{}_{} 2}}$$

Computing the minimum L₁ from the balance of forces, i.e., is

$$\\ \begin{matrix}{{B}^{{}_{} ′} \vert}_{r = 0 , z} = \frac{mg}{{M}_{d}} {⟶}^{find z} {L}_{1} & ( 10 )\end{matrix}$$

where,

$$\\ \begin{matrix}{B}^{{}_{} ′} = \frac{\partial {B}_{z}}{\partial z} = 3 \frac{{μ}_{0} {M}_{d}}{4 π} \frac{1}{{a}^{{}_{} 7}} ( 3 {r}^{{}_{} 2} z - 2 {z}^{{}_{} 3} ) & ( 11 )\end{matrix}$$

$$\\ \begin{matrix}{L}_{1}^{{}_{} *} = \sqrt[{4}_{}]{\frac{3 {μ}_{0}}{2 π} \frac{{M}_{d}^{{}_{} 2}}{mg}} & ( 12 )\end{matrix}$$

For vertical and horizontal levitation stability,

$$\\ \begin{matrix}{L}_{2} < {\{ \frac{12 {μ}_{0} {M}_{d} \vert χ \vert}{π {B}^{{}_{} ″}} \}}^{\frac{1}{5}} < {\{ \frac{24 {μ}_{0} {B}_{0} {M}_{d}^{{}_{} 3} \vert χ \vert}{{π ( mg )}^{2}} \}}^{\frac{1}{5}} & ( 13 )\end{matrix}$$

where M_{d} and m are the magnetic dipole moment and mass of the float magnet.

$$\\ \begin{matrix}{M}_{{d}_{d}} = MV , {M}_{d} = \vert M \vert V & ( 14 )\end{matrix}$$

\vec{M} is the magnetization of the magnet, V is the volume,

$$\\ \begin{matrix}\vert M \vert = Br / {μ}_{0} , V = \frac{1}{4} π {d}^{{}_{} 2} h & ( 15 )\end{matrix}$$

$$\\ \begin{matrix}{B}_{0} = \frac{{μ}_{0}}{π} \vert M \vert = \frac{Br}{π} & ( 16 )\end{matrix}$$

$$\\ \begin{matrix}{B}^{{}_{} ″} = \frac{{\partial }^{{}_{} 2} {B}_{z}}{\partial {z}^{{}_{} 2}} = 3 \frac{{μ}_{0} {M}_{d}}{4 π} \frac{1}{{a}^{{}_{} 9}} ( 3 {r}^{{}_{} 4} - 24 {r}^{{}_{} 2} {z}^{{}_{} 2} + 8 {z}^{{}_{} 4} ) & ( 17 )\end{matrix}$$

$$\\ \begin{matrix}{μ}_{0} = 4 π \times {10}^{{}_{} - 7} {NA}^{{}_{} - 2} & ( 18 )\end{matrix}$$

The relative susceptibility is μᵣ=1+χ.

The magnetic force exerted by the diamagnetic material on the magnet can then be obtained from:

$$\\ \begin{matrix}{F}_{d} = 3 \frac{{μ}_{0} {χ}_{z}}{4 π} {M}_{d}^{{}_{} 2} \frac{1}{{a}^{{}_{} 4}} & ( 19 )\end{matrix}$$

To obtain the tangent stiffness at the equilibrium point, a hyperbolic sine function fit was used to approximate each F−Δ curve, where Δ represents the displacement of the float magnet from the equilibrium point, as shown in FIG. 2. The stiffness is obtained by computing the first-order derivative of the hyperbolic function at the zero-crossing (Δ=0). The hyperbolic function relating the force, F, to the displacement, Δ, can be defined using parameters a0, a1, and a2, and the resulting value of the gradient of the force vs. displacement, as shown in Equation (20)

$$\\ \begin{matrix}{{F}_{i} = {a}_{0} + {a}_{1} sinh ( {a}_{2} {Δ}_{i} + {a}_{3} ) \frac{\partial F}{\partial Δ} \vert}_{i} = {F}_{i}^{{}_{} ′} = {a}_{1} {a}_{2} cosh ( {a}_{2} {Δ}_{i} + {a}_{3} ) & ( 20 )\end{matrix}$$

$$\\ \begin{matrix}{K = {F}_{i}^{{}_{} ′} \vert}_{Δ = 0} = {a}_{1} {a}_{2} cosh ( {a}_{3} ) & ( 21 )\end{matrix}$$

The universal gravitational constant \tilde{G} can likewise be obtained from the force-displacement relationship based on Newton's law of universal gravitation, given as

$$\\ \begin{matrix}F ( Δ ) = \tilde{G} \frac{m \cdot \tilde{m}}{{( {L}_{1}^{{}_{} *} + Δ )}^{2}} = m \cdot g , g = \frac{F ( Δ )}{m} = \frac{\tilde{G} \tilde{m}}{{( {L}_{1}^{{}_{} *} + Δ )}^{2}} & ( 22 )\end{matrix}$$

where \tilde{m} is the mass of the lift magnet, and \tilde{G} is the gravitational constant.

### Implementation of the Mathematical Foundation for Simulation

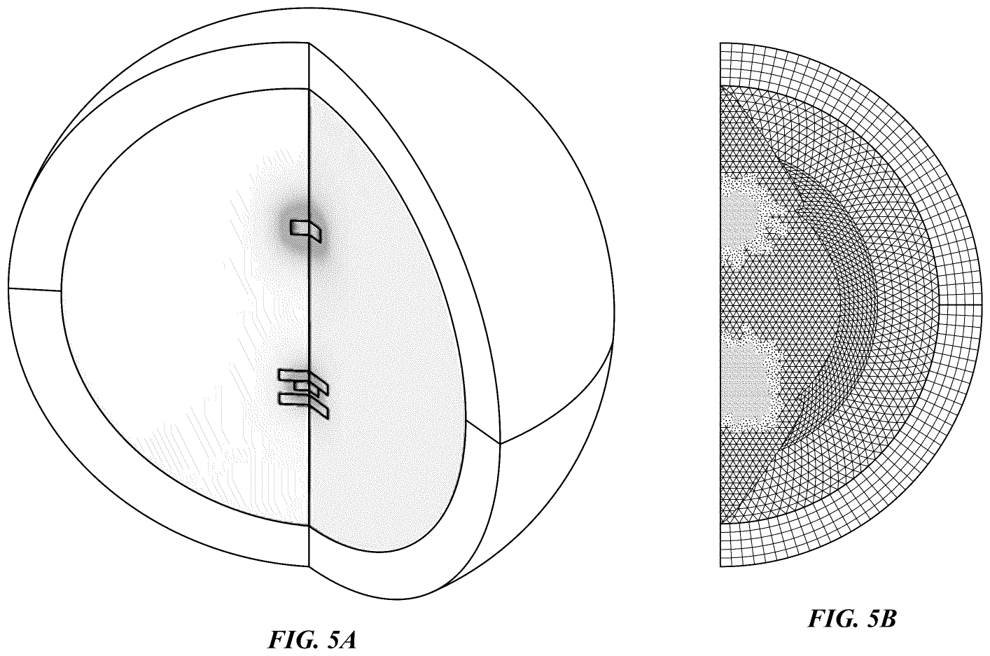

FIG. 5A is a schematic cutaway diagram of a finite element analysis (FEA) model of the DSML gravimeter. FIG. 5B is a schematic partial cross sectional diagram having a finer mesh finite element analysis (FEA) model of FIG. 4A. The top fixed float magnet, the fixed diamagnetic plates, and the movable float magnet are embedded in a general non-magnetic medium of density ρ*. The central, linear region, is surrounded by an “infinity shell” to minimize termination errors. The relative magnitude of the magnetic flux density is indicated by the blue color in FIG. 5A. The finer meshing used in the space close to the magnetic materials (magnets and diamagnetic plates) are shown in FIG. 5B.

The inventors employed finite element analysis (FEA) simulation using COMSOL Multiphysics 6.0 to determine the restoring force. The geometric model used was an axisymmetric model for 2D analysis. The simulation used the structure parameters listed in Table 1 and calculated the magnetic force between magnets and the diamagnetic force between the magnet and the diamagnet to obtain the movement space. The impact of structural parameters on the movement space of the float magnet was analyzed, and the experimental results confirmed the accuracy of the simulation.

TABLE 1
Structure parameters of the diamagnetically
stabilized magnetically levitated gravimeter

| | Lift | Floating | Diamagnetic |
|---|---|---|---|
| Parameter | magnet | Magnet | Sheet |
| Materials | NdFeB-52 | NdFeB- | HOPG |
| | | 52 | |
| Size | Φ15 × 6.35 | Φ12 × 4 | Φ25 × 5 |
| | [mm] | [mm] | [mm] |
| Residual Flux Density ( [symbol] | 1.45 | 1.45 | — |
| | [T] | [T] | |
| Recoil permeability | 1.05 | 1.05 | — |
| Electrical conductivity | 1/1.4 | 1/1.4 | 3 × 10 −3. [symbol] |
| | [μohm · m] | [μohm · | [S/m] |
| | | m] | |
| Density | | 7.5 × 10³ | — |
| | | [kg/m³] | |
| Relative permeability | — | — | 0.95 |
| Relative permittivity | — | — | 1 |

[symbol]

indicates data missing or illegible when filed

The magnetic and diamagnetic forces were calculated using a stationary study in COMSOL Multiphysics. The free-meshing algorithm using triangular elements was applied to all domains except the infinite domain region, which was mapped with a mesh of 10 elements. The maximum element size of the magnets and pyrolytic graphite sheets was set at 1.5 mm, and the meshing scale of the air domain was set to “Extremely fine” with a 2.45 mm element size. The simulation model had approximately 11,510 triangular elements in the two meshed magnets, and the elements of air surrounding the two magnets were refined to match those of the magnets. The solution time of the model on an Intel® Xeon® Gold 6136 CPU 3 GHZ and 256 GB RAM computer was 53 seconds to complete the simulation for each L₂ distance.

### Results of the Modeling and Discussion

### Initial Sensitivity Analysis

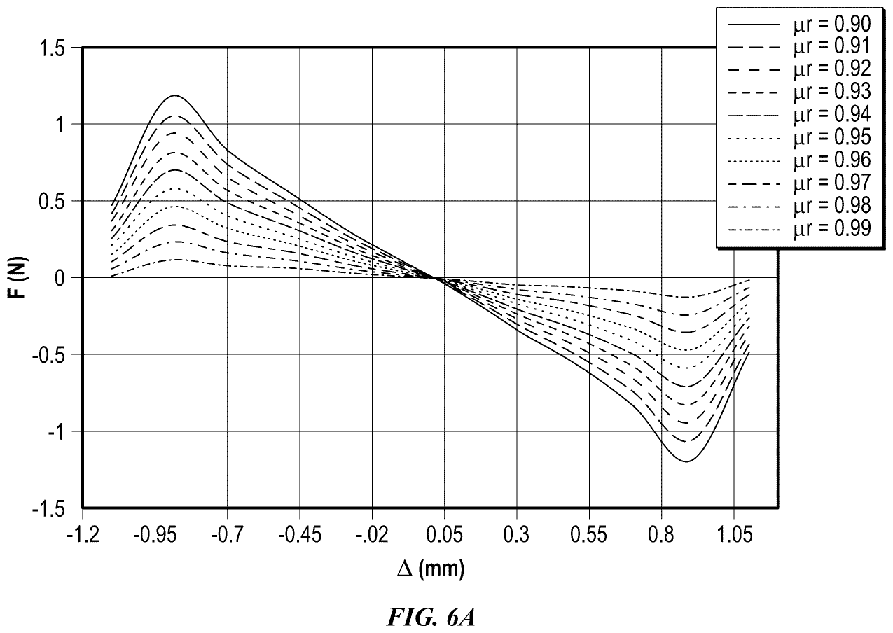

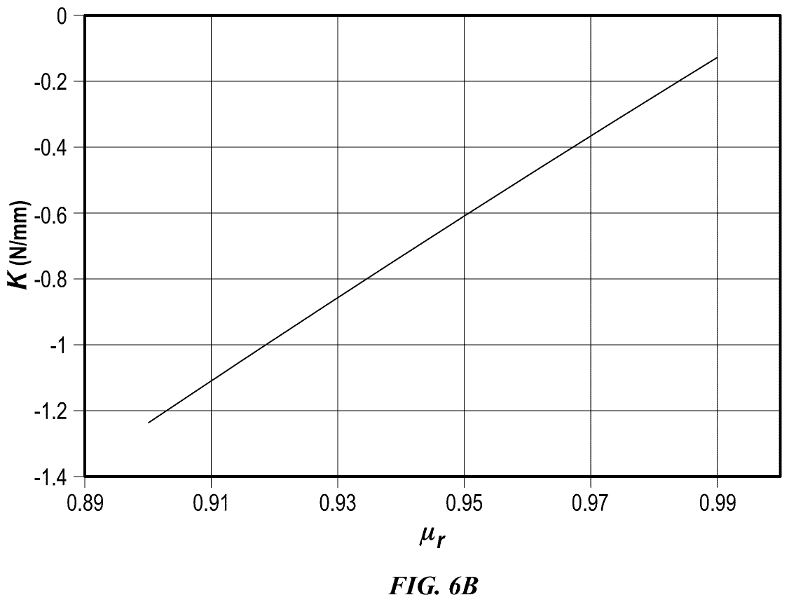

FIG. 6A is an example of a graph of restoring force in the y-axis with respect to displacement curves in the x-axis for different relative permeability. FIG. 6B is a graph of a magnetic spring constant in the y-axis with respect to the corresponding relative permeability μᵣ in the x-axis based on the results shown in FIG. 6A. For calibration purposes using FIG. 2 for identification of components and spacing, an initial sensitivity analysis was carried out for various relative permeability values of the HOPG (μᵣ) ranging from 0.90 to 0.99 in step size of 0.1 using a magnetic spacing (L₁) between the lift magnet 10 and the float magnet 4 of 70 mm and a diamagnetic spacing (L₂) between the diamagnetic materials 8 and 8′ of 6.2 mm. In FIG. 6A, the results of the sensitivity analysis are shown that higher relative permeability leads to a flatter restoring force-displacement (F−Δ) curve with smaller diamagnetic end repulsive forces and vice versa. The spring stiffness of each (F−Δ) curve (excluding the end repulsive forces) are obtained from linear regression analysis, and the results presented in FIG. 6B show a linear dependence of the resulting spring stiffness on the relative permeability. For prototyping purposes, a diamagnet with high relative permeability close to unity is advantageous, because it is expected that the DSML gravimeter will operate with magnetic forces in the order of 0.1 N.

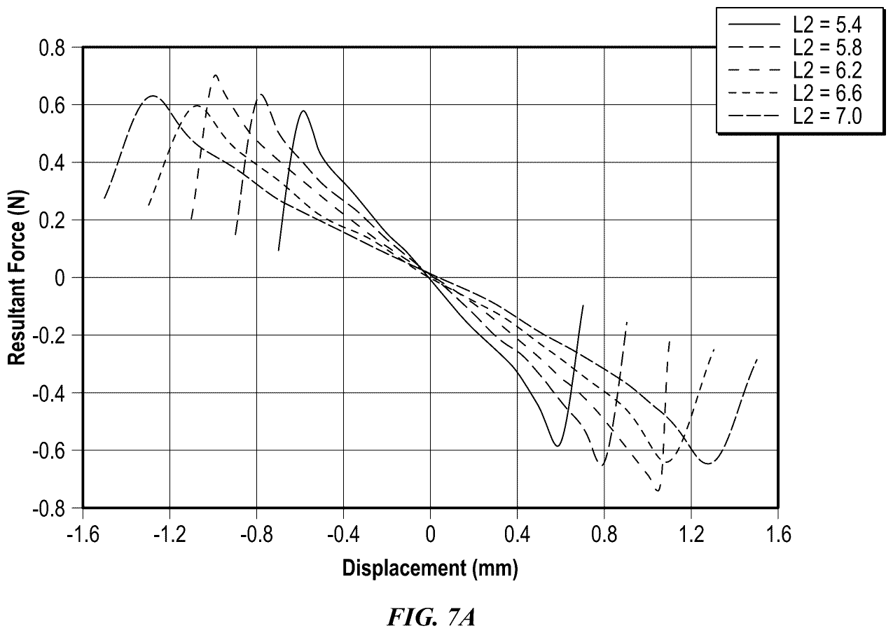

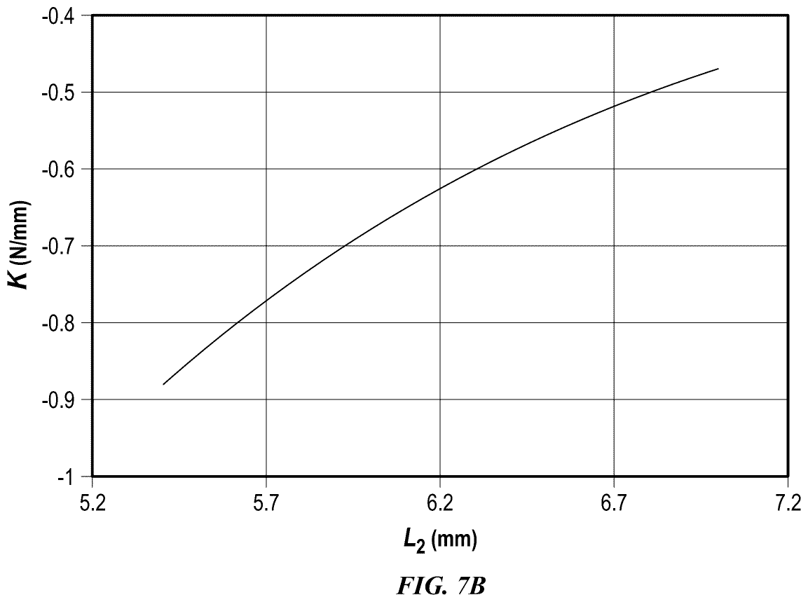

FIG. 7A is an example of a graph of restoring force in the y-axis with respect to various displacements in the x-axis for different diamagnetic spacing L₂. FIG. 7B is a graph of a magnetic spring constant in the y-axis with respect to the corresponding diamagnetic spacing L₂ displacement in the x-axis based on the results shown in FIG. 7A. A further sensitivity analysis was conducted to study the effect of varying the diamagnetic spacing L₂ on the characteristic (F−Δ) curve. The inventors used a relative permeability μᵣ of 0.95 as an average of the range in permeability discussed above, and a magnetic spacing L₁ of 70 mm between the lift magnet and the float magnet. A range of diamagnetic spacing L₂ from 5.4 mm to 7.0 mm with a step size of 0.4 mm was used for this parametric study. The results of the analysis (cf. FIGS. 7A, 7B) show that reducing the diamagnetic spacing L₂ increases the spring stiffness and the accompanying diamagnetic end repulsive forces.

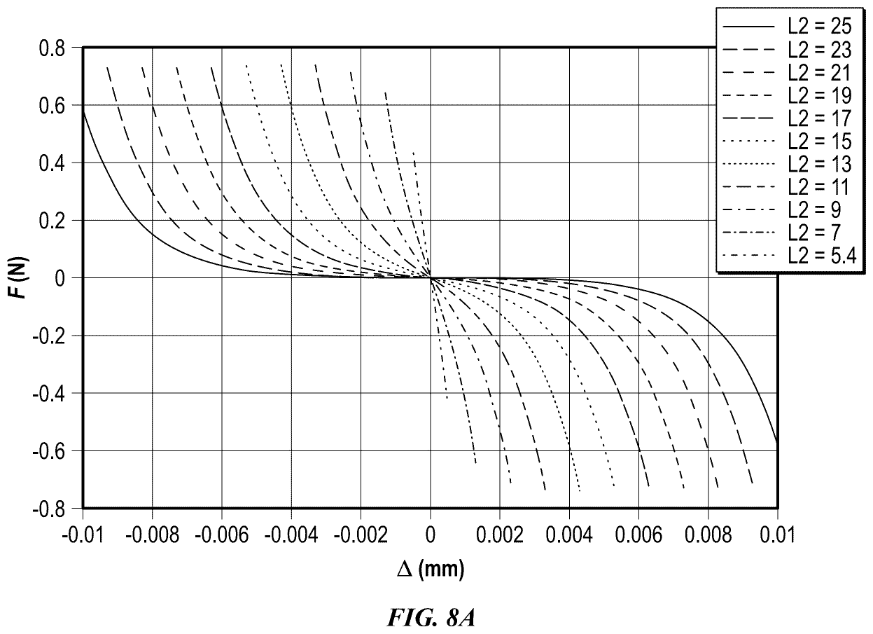

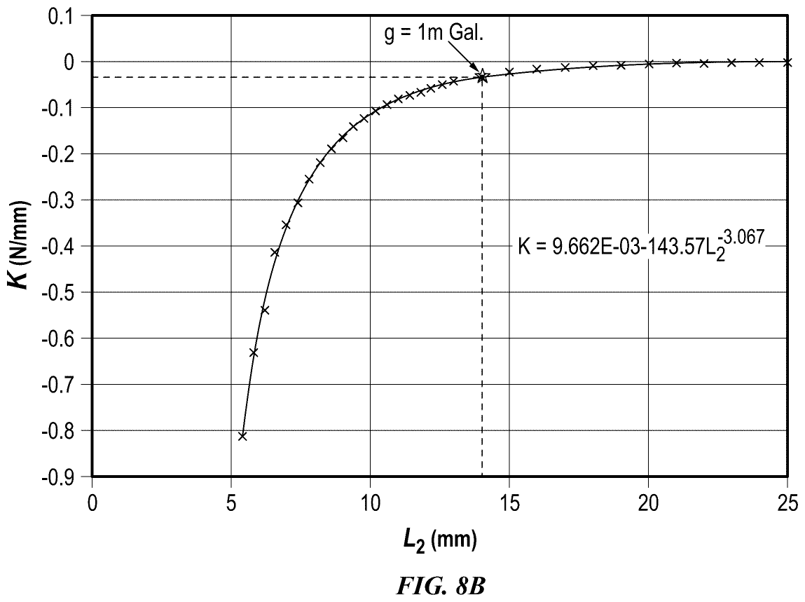

FIG. 8A is an example of a graph of restoring force with respect to various displacements for a wide range of diamagnetic spacing L₂ between the two diamagnetic materials. FIG. 8B is a graph of a magnetic spring constant gradient with respect to the diamagnetic spacing L₂ shown in FIG. 8A. Red crosses mark points at which the model was run, and the dashed green line shows the power curve for the equation shown in the figure. The black dashed lines show the hypothetical case where a change in gravitational acceleration of 1 mGal results in a displacement of 1 micron for a test mass (float magnet) of 3.4 g. As shown in FIG. 8B, the variation of the spring stiffness K, with the diamagnetic spacing L₂ is not linear. To obtain a better understanding of the general relationship between the spring stiffness K and the diamagnetic spacing L₂, an additional parametric study involving a wide range of L₂ spacing (5.4 mm to 25 mm) was carried out. The study implemented a systematic approach, employing a step size of 0.4 mm within the range of 5.4 mm to 13 mm. Subsequently, a larger step size of 1 mm was adopted from 13 mm to 25 mm. FIG. 8A shows that for higher diamagnetic spacing L₂, the nature of characteristic (F−Δ) curves are non-linear. The spring stiffness for each (F−Δ) curve is determined by obtaining the respective tangent stiffness at the neutral axis of the hyperbolic sine function regression fit approximations of actual (F−Δ) curves (excluding the end repulsive forces) based on the methodology presented in the preceding section. The resulting profile of the calculated spring stiffness for each diamagnetic spacing L₂ is shown in FIG. 8B. A power-law fit to the calculated spring-stiffness K, and diamagnetic spacing L₂, yields Equation (23) below.

$$\\ \begin{matrix}K = 0.0097 - 143.57 {L}_{2}^{{}_{} - 3.067} & ( 23 )\end{matrix}$$

The trend is that as the diamagnetic spacing L₂ approaches 0, the spring stiffness K approaches infinity, and vice versa, i.e.,

$$\\ \begin{matrix}{K \vert}_{{L}_{2} \to {}_{} 0} = - ∞ , {K \vert}_{{L}_{2} \to {}_{} ∞} = 0 & ( 24 )\end{matrix}$$

The results in FIG. 8B show that the magnetic spring constant can be tuned to an arbitrarily low value with which to construct a high-precision gravimeter by changing the diamagnetic spacing L₂. This also enables some initial gravimeter design activity. For example, if a person wishes to measure a gravitational change of 1 mGal that results in a displacement of the test mass by 1 micron, corresponding to a spring stiffness of

$$\\ 1 mGal \times {m}_{t} = K \times 1 µm ⇔ 10 [ \frac{{mm}^{2}}{s} ] \times {m}_{t} = K \times {10}^{{}_{} - 3} [ mm ]$$

where mₜ is the mass of the float magnet, which, in this case, is m=3.4×10⁻³ kg. From the derived stiffness-diamagnetic spacing relationship (cf. Equation (23)), the person could set a gravimeter with a diamagnetic spacing L₂ of 14.03 mm.

### Multidimensional Force-Displacement Parametric Study

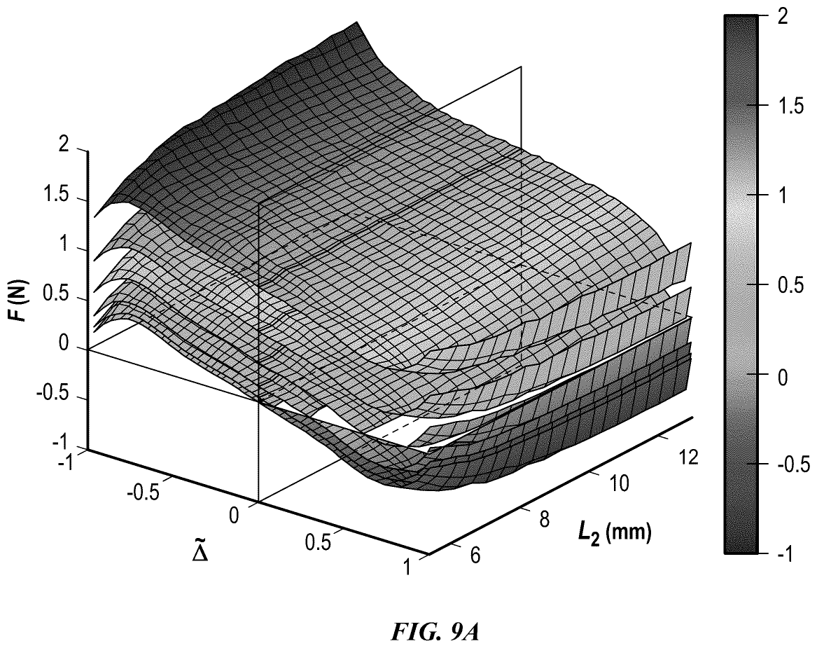

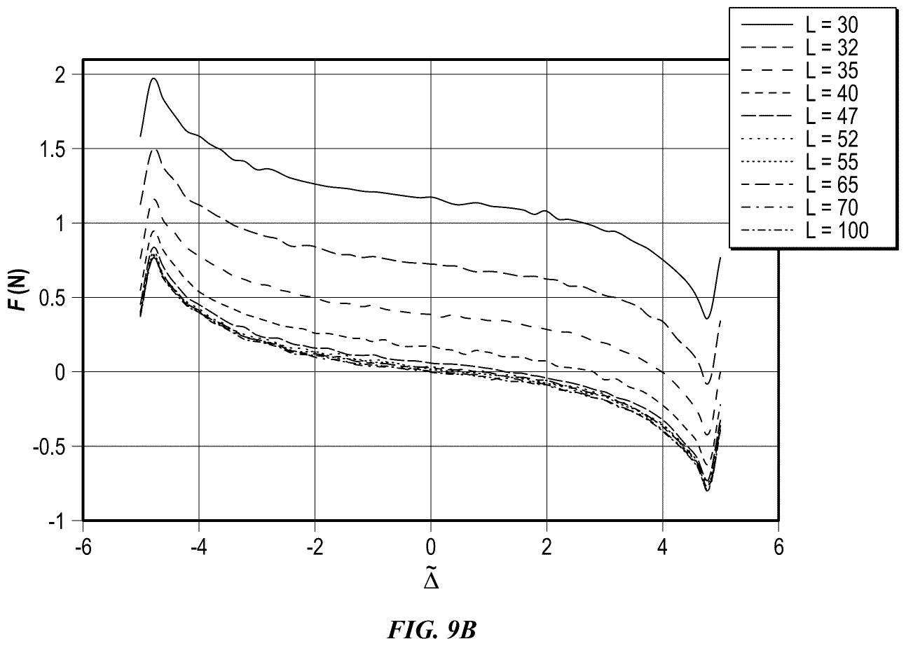

FIG. 9A is an example of a 3D surface graph of restoring force with respect to displacement on the x-axis for different diamagnetic spacing L₂ on the y-axis and magnetic spacing L₁ on the z-axis. FIG. 9B is a side view graph of restoring force with respect to displacement for diamagnetic spacing L₂=14 mm (corresponding to 1 mGal) from the information of FIG. 9A. The symbol \tilde{Δ} represents the normalized displacement and is given by \tilde{Δ}=Δ/Δ_{L}_{₂}, where Δ_{L}_{₂}=½(L₂−h). The model of the DSML gravimeter was studied for multidimensional parametric variation of the magnetic spacing L₁ between and diamagnetic spacing L₂ on the restoring force-displacement response to obtain general characteristics of the stiffness behavior for a wide range of levitation configurations. An average value of relative permeability of 0.95 for the HOPG diamagnet material was used, consistent with the prior analyses. FIG. 9A shows the results of different force-displacement-diamagnetic spacing (F−Δ−L₂) response surfaces for magnetic spacing L₁ ranging from 30 mm to 100 mm. A sideview (cf. FIG. 9B) of the 3D surfaces gives a better representation of the (F−Δ) response variation with the spacing L₁. The results show that stable equilibrium can be obtained with a magnetic spacing L₁* of 47 mm, beyond which stability conditions of magnetic levitation remain unaffected. From Equation (12) above, the minimum spacing L₁ for stable levitation was obtained as L₁*=47.3 mm. As magnetic spacing L₁ drops below L₁*, the (F−Δ) curves drift farther away from the equilibrium position. In FIG. 9A, different 3D slices are shown of the force-displacement (F−Δ) response surfaces along the L₂-axis to show that the optimum magnetic spacing L₁ for stable levitation is unaffected by the diamagnetic spacing L₂.

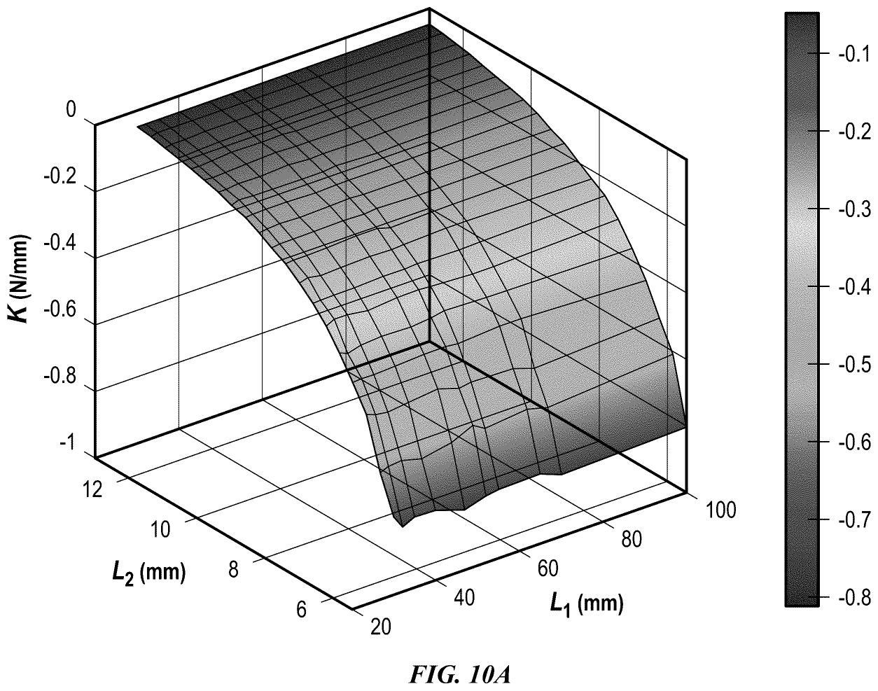

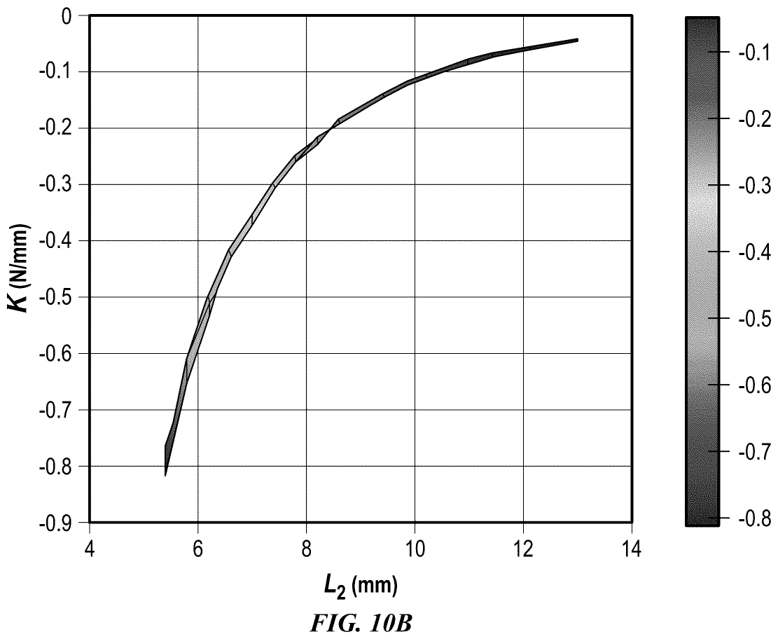

FIG. 10A is an example of a 3D surface graph of spring stiffness response on a z-axis with respect to diamagnetic spacing L₂ on an x-axis and magnetic spacing L₁ on the y-axis. FIG. 10B is a side view graph of the 3D spring stiffness response surface with respect to displacement for L₂=14 mm from the information of FIG. 10A. A 3D spring stiffness response surface (cf. FIG. 10A) can be obtained by using the same tangent stiffness algorithm of the hyperbolic sine function regression fit approximations for the different (F−Δ) responses of the various magnetic spacing L₁ and diamagnetic spacing L₂ combinations. A sideview (cf. FIG. 9B) of the 3D stiffness response surface shows that the spring constant is nearly independent of the magnetic spacing L₁, but varies non-linearly with diamagnetic spacing L₂ between the two HOPG diamagnets. As such, the spring stiffness-diamagnetic spacing correlation equation derived previously (cf. Equation (23)) is sufficient in describing the 3D response behavior without considering the magnetic spacing L₁ parameter in its definition.

Thus, decreasing the spacing L₂ between the diamagnetic material increases the spring constant and repulsive force, and conversely, increasing the spacing decreases the spring constant and can enable deploying a DSML gravimeter with a spring constant as practically weak as necessary.

### Effect of Axial Bore Through Diamagnetic Material on the Characteristic (F−Δ) Curve

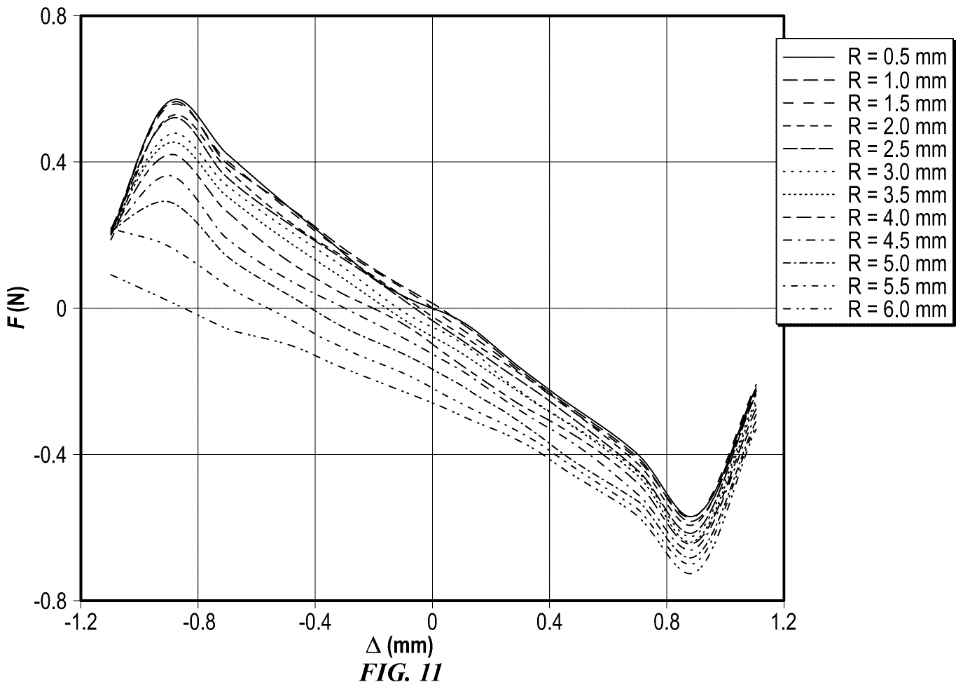

FIG. 11 is an example of a graph of force minus displacement (F−Δ) characteristic profiles for different bottom diamagnetic bore radius R. To enable measurement of the equilibrium position of the float magnet with a laser beam of an interferometer, provisions are made for the laser beam to pass through a diamagnetic materials. This beam is approximately 0.5 mm in diameter. This is achieved by creating a small, centered bore in the base HOPG diamagnet. The bore is expected to slightly alter the characteristic (F−Δ) curve depending on the bore size. The sensitivity of the forces to the size of the bore is modeled to ensure a practical instrument can still be developed and determine an appropriate bore radius that would allow complete passage of the beam with slight tolerance for disturbance without significantly altering the characteristic (F−Δ) curve.

As an example, a relative permeability μᵣ of 0.95 was used for the HOPG diamagnet materials with a diamagnetic spacing L₂ of 6.2 mm and a magnetic spacing L₁ of 70 mm. From the result of the sensitivity analysis with a bore radius R up to 2.0 mm, the characteristic (F−Δ) curve is not significantly affected. A further increase in the bore size results in an asymmetric placement of the float magnet to attain a stable equilibrium. Adding a bore in the lower diamagnetic material to enable the passage of the interferometer beam showed in this model of an embodiment that for a bore of radius up to 2.0 mm, little change in the magnet force constant was observed. However, an asymmetrical placement of the float magnet (i.e., the distance between the levitated permanent magnet to the bottom diamagnetic material is different than the distance to the top diamagnetic plate) is necessary for stable equilibrium when the diameter of the bore increases beyond one-third of the float magnet's diameter.

Other and further embodiments utilizing one or more aspects of the inventions described above can be devised without departing from the disclosed invention as defined in the claims. For example, sizes, shapes, adjustors, dampening, and other variations can each result in system variations for accomplishing goals of the invention than those specifically disclosed herein within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. A gravimeter, comprising:
at least a first diamagnetic material;
a float magnet disposed longitudinally separate from the first diamagnetic material; and
a lift magnet disposed longitudinally from the float magnet with the first diamagnetic material disposed between the lift magnet and the float magnet, the lift magnet configured to levitate the float magnet with a magnetic force that opposes a gravitational force on the float magnet while the first diamagnetic material exerts a repulsive force on the float magnet.

2. The gravimeter of claim 1, wherein the lift magnet is disposed above the float magnet and exerts an attractive force on the float magnet.

3. The gravimeter of claim 1, wherein the lift magnet opposes a gravitational force and a repulsive force from first diamagnetic material.

4. The gravimeter of claim 1, wherein the lift magnet is disposed below the float magnet and exerts a repulsive force on the float magnet.

5. The gravimeter of claim 1, further comprising a second diamagnetic material, the first diamagnetic material disposed longitudinally separate from the second diamagnetic material, and the float magnet configured to levitate longitudinally between the first diamagnetic material and the second diamagnetic material in conjunction with the lift magnet.

6. The gravimeter of claim 5, wherein at least one of the diamagnetic materials is formed with a longitudinal opening configured to allow a laser light beam to pass through the opening and shine on a surface of the float magnet.

7. The gravimeter of claim 5, wherein the lift magnet is disposed above the float magnet and exerts an attractive force on the float magnet.

8. The gravimeter of claim 1, wherein the lift magnet is disposed below the float magnet and exerts a repulsive force on the float magnet.

9. The gravimeter of claim 1, further comprising a dampener configured to stabilize movement of the float magnet while levitated.

10. The gravimeter of claim 9, wherein the dampener is configured to inductively dampen motion of the float magnet through eddy current braking.

11. The gravimeter of claim 9, wherein the dampener comprises conductive nonmagnetic material.

12. The gravimeter of claim 1, wherein the diamagnetic material is formed into a diamagnetic plate having a greater cross-sectional dimension than thickness.

13. The gravimeter of claim 1, wherein the diamagnetic material comprises pyrolytic graphite, bismuth, composite graphite having graphite particles mixed in a non-conductive composite matrix, and diamagnetic materials mixed in a composite matrix.

14. The gravimeter of claim 1, further comprising an interferometer configured to measure a longitudinal position of the float magnet.

15. A method of operating a gravimeter, comprising:
positioning a gravimeter in a first gravitational field, the gravimeter having a first diamagnetic material; a float magnet disposed longitudinally separate from the first diamagnetic material; and a lift magnet disposed longitudinally from the float magnet with the first diamagnetic material longitudinally disposed between the lift magnet and the float magnet with the float magnet levitating;
determining a first longitudinal position of the float magnet in the first gravitational field;
determining a second longitudinal position of the float magnet in a second gravitational field different than the first gravitational field; and
determining the difference between the first and second longitudinal positions to determine an amount of change between the gravitational fields.

16. The method of claim 15, wherein the float magnet levitating comprises magnetically attracting the float magnet longitudinally upward.

17. The method of claim 15, wherein the float magnet levitating comprises magnetically repulsing the float magnet upward.

18. The method of claim 15, further comprising dampening motion of the float magnet while the float magnet is levitating.

19. The method of claim 16, wherein the dampening movement of the float magnet while the float magnet is levitating comprises inductively dampening motion of the float magnet through eddy current braking.

20. The method of claim 13, wherein the determining the difference between the first and second longitudinal positions comprises measuring the positions with an interferometer.

21. A gravimeter, comprising:
a first diamagnetic material and a second diamagnetic material, the first diamagnetic material disposed longitudinally separate from the second diamagnetic material;
a float magnet disposed longitudinally between the first diamagnetic material and the second diamagnetic material; and
a lift magnet disposed longitudinally from the float magnet with at least one of the diamagnetic materials disposed between the lift magnet and the float magnet and configured to levitate the float magnet between the first and second diamagnetic materials.

22. A method of operating a gravimeter, comprising:
positioning a gravimeter in a first gravitational field, the gravimeter having a float magnet disposed longitudinally between a first diamagnetic material and a second diamagnetic material and having a lift magnet disposed longitudinally from the float magnet with at least one of the diamagnetic materials disposed between the lift magnet and the lift magnet levitating the float magnet between the diamagnetic materials;
determining a first longitudinal position of the float magnet in the first gravitational field;
determining a second longitudinal position of the float magnet in a second gravitational field different than the first gravitational field; and
determining the difference between the first and second longitudinal positions to determine an amount of change between the gravitational fields.
